(19) United States
(12) Patent Application Publication
(10) Pub. No.: US 2005/0190272 A1
(43) Pub. Date: Sep. 1, 2005

(54) Image signal processor

(75) Inventors: Tatsuya Takahashi, Ogaki-shi (JP); Tomomichi Nakai, Hashima-gun (JP)

Correspondence Address: OLIFF & BERRIDGE, PLC, P.O. BOX 19928, ALEXANDRIA, VA, 22320, US

(73) Assignee: SANYO ELECTRIC CO., LTD., Moriguchi-shi (JP)

(21) Appl. No.: 11/061,467

(22) Filed: Feb. 22, 2005

(30) Foreign Application Priority Data
Feb. 26, 2004 (JP) 2004-051120

(51) Int. Cl. H04N 5/228

(52) U.S. Cl. 348/222.1

(57) ABSTRACT

In a processor for performing image signal processing including gamma correction processing for performing nonlinear conversion, S/N deterioration in the increase of a gain such as AGC, etc. is restrained and a dynamic range is secured. Plural converting characteristic functions 90, 92, 94 used in a gamma correcting circuit are stored to the processor in advance. When both an exposure time E and a gain G are small, a characteristic setting circuit sets standard characteristics 90 to the gamma correcting circuit. When the exposure time E is large and the gain G is small, the characteristic setting circuit switches the converting characteristics to correcting characteristics 92 for setting an inclination to be small at a low signal level and restrains the amplification of a noise level at the low signal level. When the gain G is large, the characteristic setting circuit switches the converting characteristics to correcting characteristics 94 having a gentle inclination in a range wider than that of the correcting characteristics 92, and restrains that the noise level increased in proportion to the gain G is amplified by a gradation correction in the gamma correcting circuit.

### CROSS-REFERENCE TO RELATED APPLICATIONS

The priority application Number JP2004-051120 upon which this patent application is based is hereby incorporated by reference.

### FIELD OF THE INVENTION

The present invention relates to an image signal processor for making a gradation correction of an image signal and particularly relates to the restraint of a noise in gradation correction processing based on nonlinear characteristics.

### BACKGROUND OF THE INVENTION

Gradation is one of image qualities. An image pickup device such as a digital camera, etc. generally has a gradation correcting circuit for correcting this gradation. The gradation correcting circuit converts the signal level of an inputted image signal in accordance with a predetermined converting characteristic function and outputs this signal level. For example, a gamma correcting circuit is also a circuit for the gradation correction.

FIG. 1 is a typical graph showing the converting characteristics. The converting characteristics are generally nonlinear. In a portion in which the inclination of the converting characteristic function is greater than one, the change of the output image signal becomes relatively large with respect to the change of the input image signal, and the gradation is expanded. In contrast to this, in a portion in which the inclination of the converting characteristic function is smaller than one, the change of the output image signal becomes relatively small with respect to the change of the input image signal, and the gradation is compressed. The distribution of a pixel value normally has a peak on the comparatively low side of the input signal level. As shown by the characteristic curve 1 of FIG. 1, the gradation characteristics have a knee area which is a portion having a steep inclination in response to this distribution in the range of a comparatively low input signal level including this peak position. In contrast to this, a small inclination is set in the range of a comparatively high input signal level.

A noise component caused by a random noise, a dark current, etc. is included at the low input signal level of the image signal. Therefore, when a converting characteristic function steeply rising from zero with respect to the input signal as in the characteristic curve 1 is used, the signal level of the noise component is enlarged and deterioration of S/N (Signal to Noise ratio: SN ratio) might become a problem. In such a case, as shown by the characteristic curve 2 shown in FIG. 1, there is also a case using an S-shaped gamma characteristic which is a converting characteristic function of an S-shaped type in which the inclination is lowly restrained in the range of the input signal level near zero having a width according to the signal level of the noise, and the knee area is arranged in the range of the subsequent input signal level.

FIG. 2 is a block diagram showing the construction of a conventional image signal processor. Image signal processing section 4 generates a brightness signal, etc. on the basis of an image signal outputted from an image pickup device 6 such as a CCD (Charge Coupled Device) image sensor, etc., and outputs this brightness signal, etc. to an unillustrated display device, etc. Further, the image signal processing section 4 judges an exposure state and controls the operation of a driving section 8 for operating the image pickup device 6. The image signal inputted from the image pickup device 6 to the image signal processing section 4 is processed in an analog signal processing circuit 10 and is then converted into digital data in an A/D converting circuit 12 and is inputted to a digital signal processing circuit 14. An Auto Gain Control circuit (AGC) 20 for amplifying the image signal by a gain (analog gain) variably controlled is arranged in the analog signal processing circuit 10. In contrast to this, a Digital Gain Control circuit (DGC) 22 for multiplying image data outputted from the A/D converting circuit 12 by a gain (digital gain) variably controlled is arranged in the digital signal processing circuit 14. The output of the DGC 22 is inputted to a gamma correcting circuit 26 through a low pass filter (LPF) 24. In the gamma correcting circuit 26, an unchangeable nonlinear converting characteristic function is set in advance and the gamma correcting circuit 26 performs the above gradation correction processing on the basis of this function. For example, a function as in the characteristic curve 1 and the characteristic curve 2 shown in FIG. 1 is adopted as the nonlinear converting characteristic function. Further, an integral circuit 28 integrates image data outputted by the DGC 22 in one screen unit. An automatic exposure control circuit 30 performs feedback control so as to set an average level of one screen of the image signal to a desirable level by expanding and contracting an exposure time by controlling the operation of the driving section 8 and adjusting the respective gains of the AGC 20 and the DGC 22 on the basis of this integral result of the integral circuit 28.

When an object of shooting is dark, a dynamic range of the image signal outputted from the image pickup device is narrowed. In such a case, the dynamic range is secured by extending the exposure time and amplifying signals in the AGC 20 and the DGC 22. However, when the gains of the AGC 20 and the DGC 22 are raised, noises such as a random noise included in the image signal are also amplified. Further, when the exposure time is extended, the level of the dark current included in the image signal is raised so that the noise level is raised. Therefore, in this case, there is a problem in that the deterioration of S/N might become notable in the gradation correcting circuit in which the converting characteristics having a steep gradation property are set in a low signal area as in the characteristic curve 1 of FIG. 1.

On the other hand, in the gradation correcting circuit in which the converting characteristic function is set to have the S-shaped gamma characteristic or a characteristic for restraining the gradient in the knee area is set (i.e., the gentle slope is set) to restrain the S/N deterioration, there is a problem in that the gradient is lowered in an input signal range having many distributed pixels and an image having a narrow dynamic range is generated when the image signal obtained in an image pickup state (standard state) unnecessary to raise the gain, etc. is inputted.

### SUMMARY OF THE INVENTION

The present invention is made to dissolve the above problems, and its object is to restrain the deterioration of image quality due to the noise component and secure the dynamic range in the image signal processor for performing the gradation correction processing using the nonlinear converting characteristics.

An image signal processor in the present invention comprises a gain control circuit for adjusting the gain of an image signal; a gradation correcting circuit for performing gradation correction processing for converting a signal level on the basis of a nonlinear converting characteristic function with respect to the image signal after the gain adjustment; and a characteristic determining circuit for determining the converting characteristic function in accordance with the gain. In accordance with the present invention, the characteristic determining circuit changes the converting characteristic function used in the gradation correction processing in association with the gain control.

Another image signal processor in the present invention comprises a gradation correcting circuit for performing gradation correction processing for converting a signal level on the basis of a nonlinear converting characteristic function with respect to an image signal generated by an image pickup apparatus, and a characteristic determining circuit for determining the converting characteristic function in accordance with an exposure time in the image pickup apparatus. In accordance with the present invention, the characteristic determining circuit obtains the exposure time in the image pickup apparatus in generating the image signal, and changes the converting characteristic function used in the gradation correction processing in association with this exposure time.

### BRIEF DESCRIPTION OF THE DRAWINGS

FIG. 1 is a typical graph showing the converting characteristics of a gamma correcting circuit.

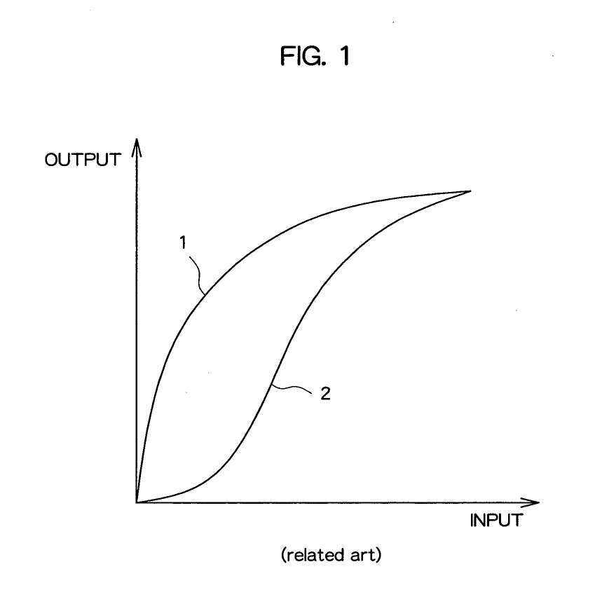

FIG. 2 is a block diagram showing the construction of a conventional image signal processor.

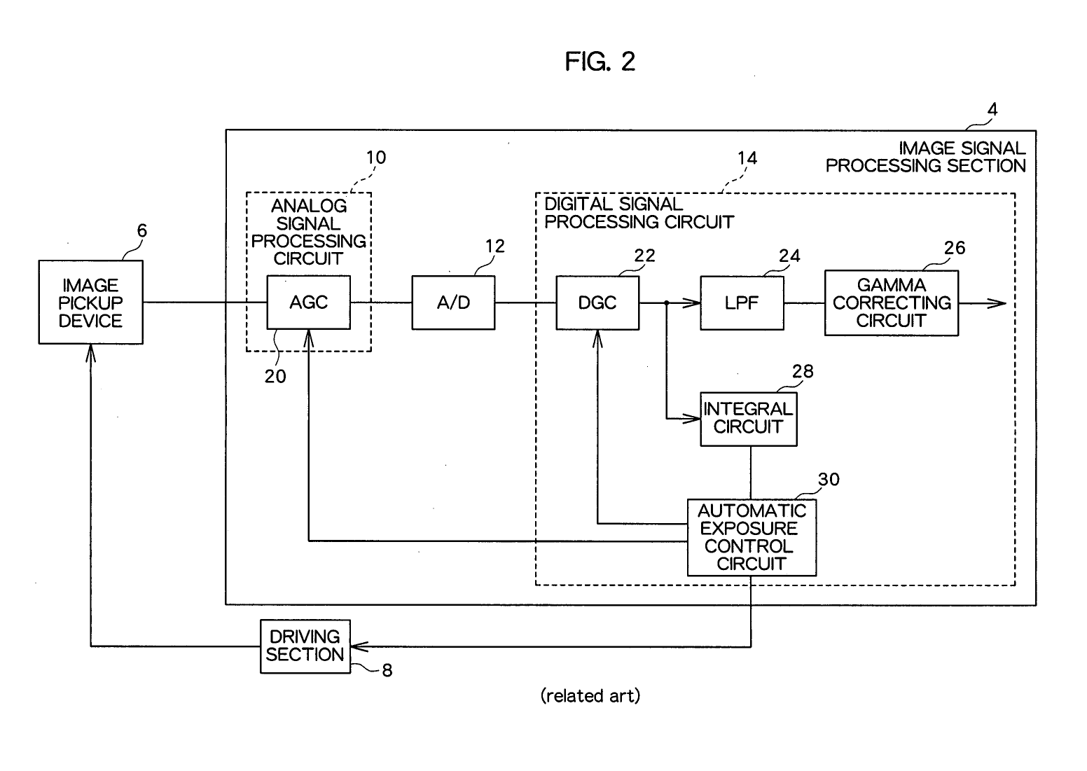

FIG. 3 is a schematic block diagram showing the construction of an image signal processor in an embodiment of the present invention.

FIG. 4 is a typical graph showing an example of plural converting characteristic functions prepared in advance in the present image signal processor.

### DESCRIPTION OF THE PREFERRED EMBODIMENTS

A basic aspect of an image signal processor in a preferable embodiment mode of the present invention will first be explained schematically.

A first basic construction of the image signal processor in the embodiment of the present invention comprises a gain control circuit for adjusting the gain of an image signal; a gradation correcting circuit for performing gradation correction processing for converting a signal level on the basis of a nonlinear converting characteristic function with respect to the image signal after the gain adjustment; and a characteristic determining circuit for determining the converting characteristic function in accordance with the gain. In this construction, the characteristic determining circuit changes the converting characteristic function used in the gradation correction processing in association with the gain control.

In one example of this image signal processor, the characteristic determining circuit determines a predetermined standard converting characteristic function when the gain used in the gain control circuit is less than a predetermined reference value, and also determines a corrected converting characteristic function in the case of a high gain range set to the reference value or more. Here, the corrected converting characteristic function has a rate of change smaller than that of the standard converting characteristic function in a low level area having an input signal level of a predetermined value or less, and approaches the standard converting characteristic function as the input signal level is increased. In this construction, for example, the entire gain range of the reference value or more is set as the high gain range and one corrected converting characteristic function can be determined for this gain range. Further, plural high gain ranges can be set in the gain range of the reference value or more and the corrected converting characteristic function can be also determined for each of these high gain ranges.

For example, the low level area is set in accordance with the signal level of a random noise after a gain adjustment in the high gain range.

A second basic construction of the image signal processor in the embodiment of the present invention comprises a gradation correcting circuit for performing gradation correction processing for converting a signal level on the basis of a nonlinear converting characteristic function with respect to an image signal generated by an image pickup apparatus, and a characteristic determining circuit for determining the converting characteristic function in accordance with an exposure time in the image pickup apparatus. In this construction, the characteristic determining circuit obtains the exposure time in the image pickup apparatus in generating the image signal, and changes the converting characteristic function used in the gradation correction processing in association with this exposure time.

In one example of this image signal processor, the characteristic determining circuit determines a predetermined standard converting characteristic function when the exposure time is less than a predetermined reference value, and also determines a corrected converting characteristic function in the case of a long exposure time range set to the reference value or more. Here, the corrected converting characteristic function has a rate of change smaller than that of the standard converting characteristic function in a low level area having an input signal level of a predetermined value or less, and approaches the standard converting characteristic function as the input signal level is increased. In this construction, the entire exposure time range of the reference value or more is set as one long exposure time range, and one corrected converting characteristic function may be determined for the long exposure time range. Further, plural long exposure time ranges may be set and plural corrected converting characteristic functions corresponding to these long exposure time ranges may be also determined.

For example, the low level area is set in accordance with the signal level of a random noise of the image signal in the long exposure time range.

A third basic construction of the image signal processor in the embodiment of the present invention comprises a gain control circuit for adjusting the gain of an image signal generated by an image pickup apparatus; a gradation correcting circuit for performing gradation correction processing for converting a signal level on the basis of a nonlinear converting characteristic function with respect to the image signal; and a characteristic determining circuit for determining the converting characteristic function in accordance with an exposure time in the image pickup apparatus and the gain. The characteristic determining circuit determines a predetermined standard converting characteristic function in the case of the gain less than a predetermined reference gain and the exposure time less than a predetermined reference exposure time, and also determines a first corrected converting characteristic function in the case of the gain less than the reference gain and the exposure time within a long exposure time range set to the reference exposure time or more, and also determines a second corrected converting characteristic function in the case of the gain within a high gain range set to the reference gain or more. Both the first corrected converting characteristic function and the second corrected converting characteristic function have a rate of change smaller than that of the standard converting characteristic function at least in a low level area having an input signal level of a predetermined value or less. Further, the first corrected converting characteristic function approaches the standard converting characteristic function at a speed faster than that of the second corrected converting characteristic function as the input signal level is increased.

For example, the low level area is set in accordance with the signal level of a random noise of the image signal in the long exposure time range.

In each of the above image signal processors, different converting characteristics are applied in the gradation correction processing in accordance with the gain control and the exposure time in the image pickup apparatus. Therefore, the gradation correction processing is performed with applying a preferable converting characteristic function according to a noise component changed by the gain and the exposure time and it is possible to obtain an image for preferably setting both the S/N characteristics and the dynamic range.

In particular, when the signal level of the noise is relatively small as in a low case of the gain and a short case of the exposure time, the standard converting characteristic function having a comparatively large inclination in the low level area of the input signal is adopted. Thus, since the original noise level is low, a wide dynamic range can be obtained while the deterioration of S/N is limited. In contrast to this, when the signal level of the noise is relatively large as in a high case of the gain and a long case of the exposure time, the modified converting characteristic function having a comparatively small inclination in the low level area of the input signal and approaching the above standard converting characteristic function with the increase of the above input signal level is adopted. Thus, while the amplification of the signal level of the noise is restrained, the dynamic range can be secured with a large inclination of the converting characteristic function at a comparatively high signal level having a little noise.

Here, the signal level of the noise is basically increased in proportion to the increase of the gain. However, the signal level increase due to the increase of the exposure time is gentle in comparison with this increase of the gain. Therefore, when both the gain and the exposure time can be adjusted, the range of the signal level for lowly restraining the inclination in the first corrected converting characteristic function corresponding to the low case of the gain and the long case of the exposure time is narrowed in comparison with the second corrected converting characteristic function corresponding to a high case of the gain. Further, the rising speed of the first converting characteristic function in the signal level range exceeding a range for restraining this inclination is increased in comparison with the second corrected converting characteristic function. In this case, the deterioration of S/N is also avoided. Namely, when the gain is low and the exposure time is long, the dynamic range can be suitably secured by applying the first corrected converting characteristic function while the deterioration of S/N is restrained. Thus, the standard converting characteristic function, the first corrected converting characteristic function and the second corrected converting characteristic function are respectively separately used when both the gain and the exposure time are small, when the gain is low and the exposure time is long, and when the gain is high. Thus, a preferable image signal adapted for each of these cases can be obtained.

The basic aspect of the image signal processor in the preferable embodiment of the present invention has been schematically explained in the above description. The concrete contents of the embodiment of the present invention will next be described in detail on the basis of the drawings.

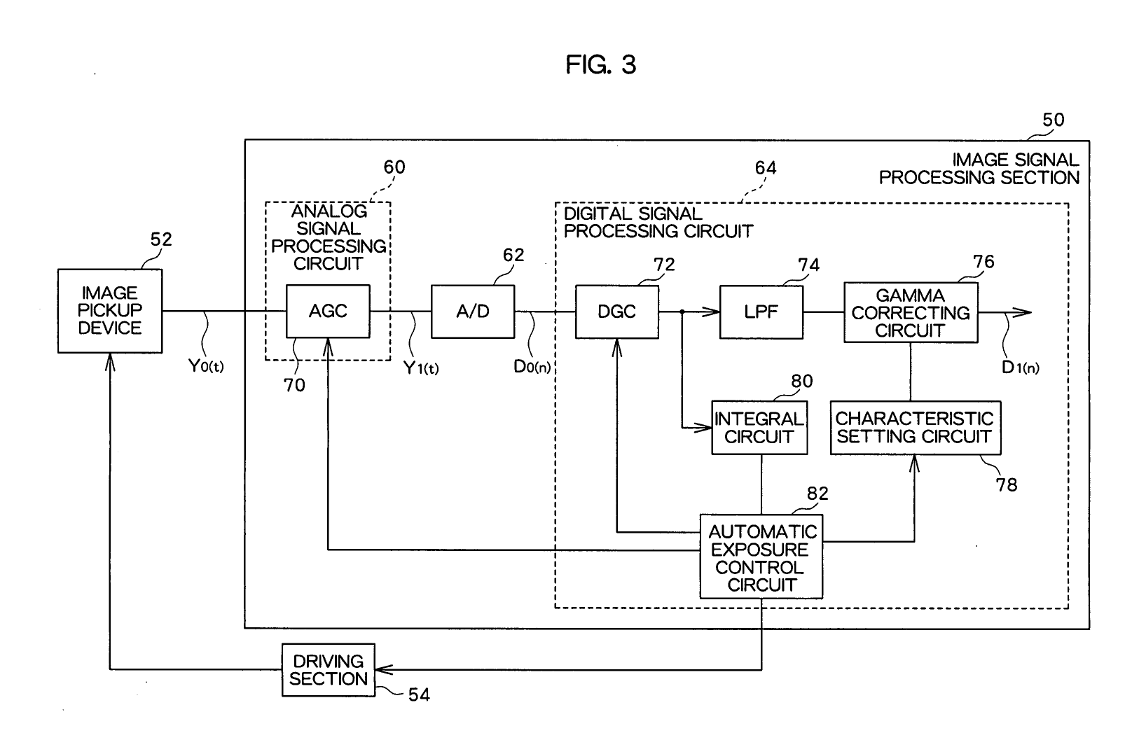

FIG. 3 is a block diagram showing the schematic construction of an image pickup device in accordance with the embodiment of the present invention. In this figure, an image signal processing section 50 corresponds to the image signal processor in the embodiment of the present invention. The image signal processing section 50 generates image data such as a brightness signal, etc. corrected in gradation on the basis of an image signal outputted from an image pickup device 52, and outputs the image data to an unillustrated display section, etc. Here, the image pickup device 52 is a CCD image sensor. An image signal Y0(t) inputted from the image pickup device 52 to the image signal processing section 50 is processed in an analog signal processing circuit 60. Thereafter, this image signal Y0(t) is converted into digital data D0(n) by an A/D converting circuit 62 and is inputted to a digital signal processing circuit 64. Further, the image signal processing section 50 has a function for judging an exposure state on the basis of the image signal and controlling the operation of a driving section 54 for operating the image pickup device 52.

The analog signal processing circuit 60 performs automatic gain control by an AGC 70 and also performs processing such as sample hold, etc. with respect to the image signal Y0(t) and generates an image signal Y1(t) according to a predetermined format. The A/D converting circuit 62 converts the image signal Y1(t) outputted from the analog signal processing circuit 60 into digital data, and outputs image data D0(n).

The digital signal processing circuit 64 fetches the image data DO (n) from the A/D converting circuit 62 and performs various kinds of processings. Here, the digital signal processing circuit 64 has a DGC 72 and performs amplification processing for multiplying the image data DO (n) by a digital gain. Further, the digital signal processing circuit 64 has a low pass filter (LPF) 74. The LPF 74 takes a brightness signal component out of the image signal obtained from the image pickup device 52, and removes and reduces noise components such as a moire noise, a random noise and a crosscut noise. The output of the DGC 72 is inputted to the LPF 74 and the brightness signal component taken out in the LPF 74 is inputted to a gamma correcting circuit 76 as image data.

The gamma correcting circuit 76 converts the signal level of the image data from the LPF 74 on the basis of the nonlinear converting characteristics, and outputs the processed data as image data Dl (n) In the present processor, the nonlinear converting characteristic function used in the gamma correcting circuit 76 is determined by a characteristic setting circuit 78. This point will be described later.

An integral circuit 80 integrates the image data outputted from the DGC 72 in one screen unit, and an automatic exposure control circuit 82 controls expansion and contraction of an exposure time E on the basis of this integral value. The driving section 54 controls timing of an electronic shutter operation, etc. in the image pickup device 52 by receiving the result of the exposure time control in the automatic exposure control circuit 82, and realizes an image pickup operation for the intended exposure time. Further, the automatic exposure control circuit 82 controls a gain (analog gain Ga) with respect to the image signal in the AGC 70, and a gain (digital gain Gd) multiplied by the image data in the DGC 72 on the basis of the integral result in the integral circuit 80.

The automatic exposure control circuit 82 performs feedback control so as to set an average level of one screen of the image signal to a desired level by adjusting the exposure time E and the gains Ga, Gd. For example, when an object of shooting is sufficiently bright, the automatic exposure control circuit 82 sets each of the gains Ga, Gd to a default value “1” and controls the integral value I of the image signal from the integral circuit 80 so as to approach a target value by increasing and decreasing only the exposure time E. When the integral value I is smaller than the target value even when the exposure time E is increased until an upper limit value, the automatic exposure control circuit 82 next performs control for making the integral value approach the target value by increasing the analog gain Ga while the exposure time E is held to the upper limit value. When the integral value I is smaller than the target value even when the analog gain Ga is increased until the upper limit value, the automatic exposure control circuit 82 next performs control for making the integral value I approach the target value by increasing the digital gain Gd while the exposure time E and the analog gain Ga are held to the upper limit values.

The characteristic setting circuit 78 obtains E, Ga, Gd set at present from the automatic exposure control circuit 82, and selects one of plural converting characteristic functions on the basis of these values and sets the selected one to the gamma correcting circuit 76.

The digital signal processing circuit 64 can further perform other signal processings of color separation, a contour correction, etc., but their explanations are omitted here.

The gradation correction processing in the present processor will next be explained. As mentioned above, the gradation correction processing is performed by converting an input signal level by using the converting characteristic function in the gamma correcting circuit 76. The converting characteristic function showing the correspondence of the input signal level and an output signal level is determined by the characteristic setting circuit 78 on the basis of the exposure time E, and the gains Ga, Gd obtained from the automatic exposure control circuit 82.

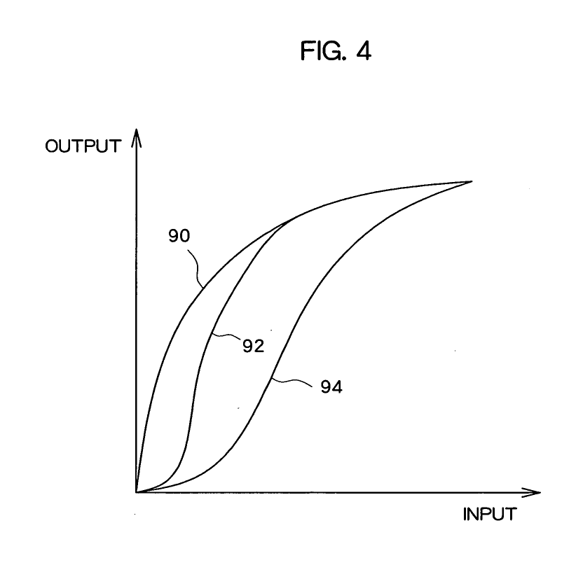

FIG. 4 is a typical graph showing an example of plural converting characteristic functions prepared in advance in the present processor. In this figure, the axis of abscissa shows the input signal level x, and the axis of ordinate shows the output signal level y. A converting characteristic function 90 (y=F0(x)) shows a function corresponding to a case in which the exposure time E is comparatively short. A converting characteristic function 92 (y=F1(x)) shows a function corresponding to a case in which the exposure time E is set to be comparatively long. A converting characteristic function 94 (y=F2(x)) shows a function corresponding to a case in which a synthetic gain G given by the product of two gains Ga, Gd is set to be comparatively large. For example, a definition area x (i.e., an allowable range of the input signal level) of the function is divided into plural intervals, and each converting characteristic function is stored to the processor in the shape of a linear approximate function at each interval. For example, in the characteristic setting circuit 78, a parameter (e.g., a set of an inclination and an ordinate axis cutting piece) showing the linear approximate function every interval is set to a built-in memory device in advance in the format of a table, etc.

The converting characteristic function 90 basically steeply rises from the input signal level x=0 in an inclination e.g., F0′ (x)>1. The inclination F0′ (x) is set so as to be reduced with an increase of x. On the other hand, converting characteristic functions 92, 94 have S-shaped gamma characteristics, and also have small inclinations in comparison with the converting characteristic function 90 in a low level area in which the value x is a predetermined value or less. In this low level area, the output signal level is converted into a small value in comparison with the input signal level. For example, inclinations μl′ (x)<1 and F2′ (x)<1 are formed with respect to at least x near 0. In comparison with the converting characteristic function 94, the converting characteristic function 92 rapidly rises with the increase of x, and rapidly approaches the standard converting characteristic function 90.

The characteristic setting circuit 78 compares the exposure time E and a predetermined threshold value (reference exposure time) e set in advance. If E<e, the converting characteristic function 90 is set to the gamma correcting circuit 76. In contrast to this, if E≧ηe, the characteristic setting circuit 78 further compares the synthetic gain G and a predetermined threshold value (reference gain) ηg set in advance. If G<μg, the converting characteristic function 92 is set to the gamma correcting circuit 76. In contrast to this, if E≧ηe and G≧ηg, the converting characteristic function 94 is set to the gamma correcting circuit 76. For example, each converting characteristic function is set to the gamma correcting circuit 76 by reading a parameter showing each converting characteristic function stored to the characteristic setting circuit 78 and setting this parameter to the gamma correcting circuit 76.

Here, in general, a dark current component included in the image signal is increased and S/N is deteriorated when the exposure time is lengthened. The reference exposure time ηe is set within the exposure time at which the S/N of an image corrected in gradation by the converting characteristic function 90 lies within an allowable range.

The inclinations are reduced in the low level areas of the converting characteristic functions 92, 94 since S/N is preferably held so as not to convert a noise component able to be included in the low level area into a large output signal level. Accordingly, the low level area for restraining the inclination in each of the converting characteristic functions 92, 94 is determined in accordance with the magnitude of the noise at the exposure time E and the gain G at which each of the converting characteristic functions 92, 94 is applied. Further, the inclination in this low level area is determined in accordance with the allowed S/N. Here, since the signal level of the noise is basically increased in proportion to the gain G, the signal level of the noise in the case of G>ηg might be greater than that in the case of G<ηg with respect to the image signal inputted to the gamma correcting circuit 76. In response to this, the low level area for restraining the above inclination is set to be comparatively narrow in the converting characteristic function 92, and the converting characteristic function 92 is set so as to steeply rise at the input signal level exceeding this low level area. On the other hand, the converting characteristic function 94 is set such that the inclination is restrained in a wide range and this converting characteristic function gently rises.

In the construction described above, one ηe and one ηg are set with respect to each of the exposure time E and the synthetic gain G, and correspondingly in response to two threshold values 1e and 1g, two corrected converting characteristic functions 92, 94 are prepared in addition to the standard converting characteristic function 90, and the characteristic setting circuit 78 selects these converting characteristic functions has been explained. However, a construction for making the selection from more converting characteristic functions by increasing the number of threshold values with respect to the exposure time E and the synthetic gain G may be also used. For example, when an upper limit value of the exposure time E is set to L and an upper limit value of the analog gain Ga is set to Ma and an upper limit value of the digital gain Gd is set to Md, the processor can be set such that applied converting characteristic functions are respectively prepared in the case of E≧ηe and G=1, the case of E=L and 1<G<Ma and the case of E=L and Ma<G≦Ma·Md in addition to the standard converting characteristic function 90 applied in E<ηe, and the characteristic setting circuit 78 selects these converting characteristic functions on the basis of the exposure time E, the analog gain Ga and the digital gain Gd.

Further, the present invention can be also applied when only the exposure time E is changed and when only the gain G is changed. For example, the processor can be also constructed such that the converting characteristic function 90 is selected in the case of E<ηe and the converting characteristic function 92 is selected in the case of E≧ηe. Further, for example, the processor can be also constructed such that the converting characteristic function 90 is selected in the case of G<ηg and the converting characteristic function 94 is selected in the case of G≧ηg. Here, the converting characteristic function 92 is adopted as a corrected converting characteristic function when the exposure time E is increased. The converting characteristic function 94 is adopted as a corrected converting characteristic function when the synthetic gain G is increased. This adoption is performed in accordance with the difference that the changing ratio of the signal level of the noise is small in comparison with the change of the exposure time E, but the signal level of the noise is basically increased in proportion to the increase of the gain G. Namely, the change of the signal level of the noise is comparatively small while the exposure time E is changed from ηe to the upper limit value. In contrast to this, when the synthetic gain G rises, the signal level of the noise is greatly changed in proportion to the gain G. Accordingly, it might be preferable to set the converting characteristic functions as mentioned above.

1. An image signal processor comprising:
again control circuit for adjusting the gain of an image signal;
a gradation correcting circuit for performing gradation correction processing for converting a signal level on the basis of a nonlinear converting characteristic function with respect to the image signal after the gain adjustment; and
a characteristic determining circuit for determining said converting characteristic function in accordance with said gain.

2. The image signal processor according to claim 1, wherein
said characteristic determining circuit determines a predetermined standard converting characteristic function when said gain used in said gain control circuit is less than a predetermined reference value, and also determines a corrected converting characteristic function in the case of a high gain range set to said reference value or more; and
said corrected converting characteristic function has a rate of change smaller than that of said standard converting characteristic function in a low level area having an input signal level of a predetermined value or less, and approaches said standard converting characteristic function as said input signal level is increased.

3. The image signal processor according to claim 2, wherein said low level area is determined in accordance with the signal level of a random noise after a gain adjustment in said high gain range.

4. An image signal processor comprising:
a gradation correcting circuit for performing gradation correction processing for converting a signal level on the basis of a nonlinear converting characteristic function with respect to an image signal generated by an image pickup apparatus, and
a characteristic determining circuit for determining said converting characteristic function in accordance with an exposure time in said image pickup apparatus.

5. The image signal processor according to claim 4, wherein
said characteristic determining circuit determines a predetermined standard converting characteristic function when said exposure time is less than a predetermined reference value, and also determines a corrected converting characteristic function in the case of a long exposure time range set to said reference value or more, and
said corrected converting characteristic function has a rate of change smaller than that of said standard converting characteristic function in a low level area having an input signal level of a predetermined value or less, and approaches said standard converting characteristic function as said input signal level is increased.

6. The image signal processor according to claim 5, wherein
said low level area is determined in accordance with the signal level of a random noise of said image signal in said long exposure time range.

7. An image signal processor comprising:
a gain control circuit for adjusting the gain of an image signal generated by an image pickup device;
a gradation correcting circuit for performing gradation correction processing for converting a signal level on the basis of a nonlinear converting characteristic function with respect to said image signal; and
a characteristic determining circuit for determining said converting characteristic function in accordance with an exposure time in said image pickup apparatus and said gain;
wherein said characteristic determining circuit determines a predetermined standard converting characteristic function in the case of said gain less than a predetermined reference gain and said exposure time less than a predetermined reference exposure time, and also determines a first corrected converting characteristic function in the case of said gain less than said reference gain and said exposure time within a long exposure time range set to said reference exposure time or more, and also determines a second corrected converting characteristic function in the case of said gain within a high gain range set to said reference gain or more, and
both said first corrected converting characteristic function and said second corrected converting characteristic function have a rate of change smaller than that of said standard converting characteristic function at least in a low level area having an input signal level of a predetermined value or less, and said first corrected converting characteristic function approaches said standard converting characteristic function at a speed faster than that of said second corrected converting characteristic function as said input signal level is increased.

8. The image signal processor according to claim 7, wherein
said low level area is determined in accordance with the signal level of a random noise of said image signal in said long exposure time range.
